(19) United States
(12) Patent Application Publication
(10) Pub. No.: US 2015/0161810 A1
(43) Pub. Date: Jun. 11, 2015

(54) POSITION BASED FLUID DYNAMICS SIMULATION

(71) Applicant: NVIDIA Corporation, Santa Clara, CA (US)

(72) Inventors: Miles MACKLIN, Auckland (NZ); Matthias MULLER, Uerikon (CH)

(73) Assignee: NVIDIA Corporation, Santa Clara, CA (US)

(21) Appl. No.: 14/102,323

(22) Filed: Dec. 10, 2013

(51) Int. Cl. G06T 13/60

(52) U.S. Cl. CPC G06T 13/60; G06T 2210/24; G06T 2213/12

(57) ABSTRACT

Systems and methods for providing a mechanism of simulating fluid dynamics while maintaining the incompressibility of a fluid based on a position based dynamics (PBD) framework. A set of constraint equations that enforce constant density of the particles in a fluid object are formulated in terms of neighbor particle positions. The formulated constraint equations can be solved iteratively in a Jacobi method to obtain a new position and new velocity of each particle in large time steps. Voracity confinement may be introduced to simulate turbulent motions of the fluid object based on an unnormalized curl of the particle velocities. A positive artificial pressure term can be incorporated in particle position updates to reduce particle clustering or clumping effect caused by negative pressures related to neighbor deficiencies.

### TECHNICAL FIELD

The present disclosure relates generally to the field of computational dynamics, and, more specifically, to the field of computational fluid dynamics.

### BACKGROUND

Fluids, such as liquids, smoke, fire, explosions and related phenomena, are responsible for many visually rich image, and simulating them has been an area of long-standing interest and challenges in computer graphics. In fluid simulation, enforcing incompressibility or constant density of a fluid object is crucial for realism and yet computationally expensive.

There are a variety of techniques available for fluid dynamics simulation, including grid based methods and particle based methods. Particle based methods are popular for their simplicity and flexibility. Smoothed particle hydrodynamics (SPH) is a particle based method for fluid simulation and has many attractive properties: mass-conservation; Lagrangian discretization (particularly useful in games where the simulation domain is often not known in advance); and conceptual simplicity. However, SPH is sensitive to density fluctuations from neighborhood deficiencies, and enforcing incompressibility is computationally costly due to the unstructured nature of the model. Recent work has improved efficiency by an order of magnitude, but unfortunately it requires small time steps, thereby limiting real-time applications.

For interactive application environments, computation robustness is a key issue; the simulation needs to handle degenerate situations gracefully. SPH algorithms often become unstable if the particles do not have enough neighbors for valid density estimates. A typical solution to avoid these situations is by taking sufficiently small time steps, or by using sufficiently many particles, at the cost of increased computation.

SPH can be used for interactive fluid simulation by incorporating viscosity and surface tension by using a low stiffness equation of state (EOS). However to maintain incompressibility, standard SPH or weakly compressible SPH (WCSPH) require stiff equations, resulting in large forces that limit the time-step size. Predictive-corrective incompressible SPH (PCISPH) relaxes this time-step restriction by using an iterative Jacobi-style method that accumulates pressure changes and applies forces until convergence. It has the advantage of not requiring a user-specified stiffness value and of amortizing the cost of neighbor-finding over many density corrections. Based on this framework, related work has been developed to solve incompressibility iteratively by setting up density constraints as a linear complementarity problem through a Gauss-Seidel iteration.

A hybrid approach that combines particle based and grid based methods has also been used to simulate fluid dynamics. For example, a grid is used to solve for pressure, and then velocity changes are transferred back to particles. A fluid implicit particle (FLIP) method can simulate incompressible flow with free surfaces. However, in an interactive setting, where the domain is not known as a priori, grid based methods are generally not applicable.

Position based dynamics (PBD) provides a simulation approach that enables direct control over positions of objects or vertices of a mesh. PBD has been previously used for simulating dynamics in electronic games based on Vertlet integration, where a system of non-linear constraints are solved using Gauss-Seidel iteration by updating particle positions directly. By eschewing forces and deriving momentum changes implicitly from the position updates, the typical instability associated with explicit methods can be avoided.

### SUMMARY OF THE INVENTION

Therefore, it would be advantageous to provide a mechanism of simulating fluid dynamics while maintaining the incompressibility of a fluid object with high computational efficiency and stability. Embodiments of the present disclosure employ a computer implemented method of simulation of incompressible flow based on a position based dynamics (PBD) method. A set of constraints that enforce constant density of the particles in a fluid object are formulated in terms of neighbor particle positions. The formulated constraint equations can be solved iteratively in a Jacobi method to obtain a new position and new velocity of each particle in large time steps, as offered by the position based dynamics (PBD) framework, which makes the method suitable for real-time applications. Therefore, such a method can advantageously simulate incompressibility of a fluid object with computational convergence, and stability. Further, vorticity confinement may be introduced to simulate turbulent motion of the fluid object based on an unnormalized curl of the particle velocities. Moreover, a positive artificial pressure term can be incorporated in particle position updates to reduce particle clustering or clumping effects caused by negative pressure when a particle has too few neighbors.

In accordance with an embodiment of the present disclosure, a computer implemented method of fluid simulation of a fluid object comprises: (1) determining first positions of a plurality of particles based on external forces applied thereon; (2) identifying neighbor particles for a respective particle based on the first positions; and (3) determining a second position of the respective particle based on a constraint function representing that a density associated with the respective particle at the second position is approximately equal to a rest density of the fluid object, wherein the constraint function is a function of positions of the neighbor particles. The second position may be determined by: computing a position correction for the respective particle based on the constraint function; adding the position correction with a first position of the respective particle to generate the second position; and designating the second position as a new position of the respective particle.

The position correction may be proportional to a gradient of the constraint function. The position correction can be computed by iteratively computing the gradient, a scaling factor, and the position correction in accordance with a substantially Newton-Raphson method and a substantially Jacobi iteration method. The density may be defined based on a smoothing kernel function having a vanishing gradient at a kernel boundary, and further comprising pre-computing a corrective scale based on a reference particle configuration with a filled neighborhood in accordance with a predictive-corrective incompressibility smoothed-particle hydrodynamics (PCISPH) method. The method may further comprise: defining a positive artificial pressure in terms of the smoothing kernel function; and adding the positive artificial pressure to the scaling factor.

In another embodiment of present disclosure, a system comprises: a processing unit; and a non-transient computer-readable storage medium storing a fluid dynamics simulation program embodying instructions that cause the processing unit to perform: (a) accessing first positions of a plurality of particles in a fluid object based on an external force applied on the plurality of particles; (b) identifying neighbor particles for a respective particle based on the first positions; and (c) determining a position correction of the respective particle based on a constraint function representing that a density associated with the respective particle at the second position is approximately equal to a rest density of the fluid object, wherein the constraint function is a function of positions of the neighbor particles; and (d) determining a second position of the respective particle by adding the position correction to a first position of the respective particle; (e) designating the second position as a new position of the respective particle; and (f) repeating the (b) through (e) for all remaining particles of the plurality of particles.

In another embodiment of present disclosure, a computer implemented method of simulating fluid dynamics of an incompressible fluid object comprises: (1) determining first velocities and first positions of a plurality of particles in the incompressible fluid object based on an external force applied on the incompressible fluid object; (2) identifying a set of neighbor particles for a respective particle of the plurality of particles based on the first positions; (3) determining a second position of the respective particle based on a constraint that a density associated with the respective particle at the second position is approximately equal to a rest density of the incompressible fluid object; and (4) determining a second velocity of the respective particle based on a difference between a first position of the respective particle and the second position.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 is a flow chart depicting an exemplary computer implemented method of simulating dynamics of fluid object while maintaining incompressibility thereof by projecting positional density constraints on particles in accordance with an embodiment of the present disclosure.

FIG. 2 is a flow chart depicting an exemplary computer method of computing a new position of a center particle based by iteratively solving a constraint equation in accordance with an embodiment of the present disclosure.

FIG. 3 is a data plot showing an exemplary pressure term for |Δq|=0.1h, k=0.1 and n=4.

FIG. 4A is a sample illustration of a splashing scenario that is simulated without using an artificial pressure term in accordance with an embodiment of the present disclosure.

FIG. 4B is a sample illustration of the splashing scenario that is simulated by incorporating an artificial pressure term in accordance with an embodiment of the present disclosure.

FIG. 5A is a sample illustration of a dam break scenarios that is simulated without incorporating vorticity confinement in accordance with an embodiment of the present disclosure.

FIG. 5B is sample illustration of the dam break scenarios that is simulated by incorporating vorticity confinement in accordance with an embodiment of the present disclosure.

FIG. 6 is a sample illustration of a bunny taking a bath scenario that is simulated in accordance with an embodiment of the present disclosure.

FIG. 7 is a sample illustration showing a liquid bunny is dropped into a pool of water that is simulated based on the algorithm provided by Table 1 in accordance with an embodiment of the present disclosure.

FIG. 8 shows data plots comparing average density over the bunny drop simulation resulted from a conventional PCISPH method and an embodiment of the present disclosure.

FIG. 9 is a data plot showing convergence performance of an exemplary simulation process that generates the scenario shown in FIG. 7 in accordance with an embodiment of the present disclosure.

FIG. 10 is a sample illustration showing a water puddle scenario with webbing effect that is generated in accordance with an embodiment of the present disclosure.

FIG. 11 is a block diagram illustrating an exemplary computing system including a fluid dynamics simulation program in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature:

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

### Position Based Fluid Dynamics Simulation

In general, position based dynamics (PBD) provides a mechanism for simulating dynamics by solving a system of non-linear constraints by updating particle positions directly. By eschewing forces and deriving momentum changes implicitly from the position updates, the typical instabilities associated with explicit methods can be avoided.

According to the present disclosure, incompressibility of a simulated fluid object can be achieved by projecting uniform density constraints on the particles in the fluid object. Such a constraint can be defined using an equation of state in which density associated with a respective particle is related directly to spatial distances between the respective particle and its neighbor particles. As a result, a new position and new velocity of a respective particle can be derived by solving the equation.

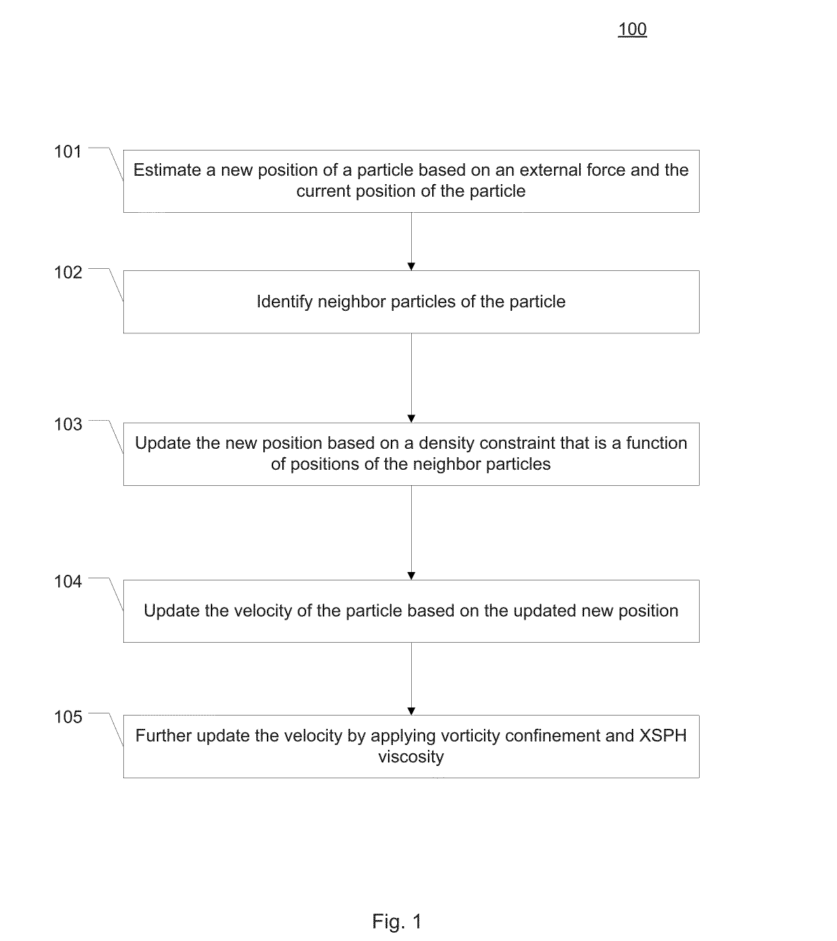

FIG. 1 is a flow chart depicting an exemplary computer implemented method 100 of simulating dynamics of fluid object while maintaining incompressibility thereof by projecting positional density constraints on particles in accordance with an embodiment of the present disclosure. With respect to a respective particle, or the center particle, its new position can be initially estimated based on an external force and the current position of the particle at 101. At 102, a set of neighbor particles of the center particle are identified. For instance, neighbor particles can be identified based on those particles within a predefined cut-off distance from the center particle.

Then, based on a density constraint projected on the center particle, the estimated new position can be advantageously adjusted, or updated, at 103. The density constraint can be expressed as an equation of state that correlates a density associated with the center particle to positions of the identified neighbor particles. The new position of the center particle can thus be updated by iteratively solving the equation of state. At 104, the velocity of the center particle can be derived based on a difference between the current position and the updated new position.

It will be appreciated that the new position and velocity of the center particle can be further adjusted to achieve other simulated properties, effects, and/or phenomena related to the fluid object. For example, at 105, voracity confinement and viscosity can be optionally taken into account to derive a new velocity representing a spinning motion of the particle to achieve a turbulence motion of the fluid object for example. The viscosity may be defined in accordance with a smoothed particle hydrodynamics method (SPH), e.g., XSPH. In some embodiments, collision detection and response are also performed to further adjust the new position of the center particle, e.g., by projection-relevant constraints.

In some embodiments, a system of non-linear constraints can be solved to enforce constant density, with one constraint projected on each particle of a fluid object. Each constraint can be expressed as a function of the center particle's position and the positions of its neighbors, herein referred to collectively as p₁, . . . , pₙ.

Consistent with a PBD framework, the density constraint on the i^{th} particle can be defined using an equation of state:

$$C ( {p}_{l} , ⋯ , {p}_{α} ) = \frac{{ρ}_{i}}{{ρ}_{0}} - 1 , \qquad ( 1 )$$

where ρ₀ is the rest density of the fluid object.

It will be appreciated that, the present disclosure is not limited to any specific constraint formula and/or equation that can enforce incompressibility or uniform density on a simulated fluid object. In some embodiments, ρᵢ is given by the standard SPH density estimator:

$${ρ}_{i} = {\sum }_{j} {m}_{j} W ( {p}_{i} - {p}_{j} , h ) , \qquad ( 2 )$$

where mⱼ represents the mass of the j^{th} neighbor particle, W is a smoothing kernel function corresponding to the contribution of a neighbor particle to the ρᵢ and h is the corresponding smoothing length. Any suitable form of kernel function that are well known in the art can be used to correlate ρᵢ to the particle positions p₁, . . . , pₙ, such as a Gaussian function. In some embodiments, all particles can be treated as having equal mass. For purposes of simplification, the mass term is dropped from subsequent equations.

Provided with a set of estimated particle positions, p₁, . . . , pₙ, that do not necessarily satisfy the density constraints, a particle position correction that satisfies the density constraint can be derived by solving

C(p+Δp)=0. (3)

This is found by a series of Newton steps along the constraint gradient:

Δp≈∇C(p)λ (4)

C(p+Δp)≈C(p)+∇C^{T}Δp=0 (5)

C(p+Δp)≈C(p)+∇C^{T}∇Cλ=0 (6)

Applying a recipe for the gradient of a function on the particles in accordance with a smoothed particle hydrodynamics (SPH) method, the gradient of the constraint function (1) with respect to a particle k is given by:

$${∇}_{{p}_{i}} C = \frac{1}{{ρ}_{0}} {∇}_{{p}_{i}} W ( {p}_{i} - {p}_{j} , h ) \qquad ( 7 )$$

Placing (7) into (6) and solving for λ gives:

$${λ}_{i} = - \frac{{C}_{i} ( {p}_{l} , ⋯ , {p}_{n} )}{{\sum }_{k} {\vert {∇}_{{p}_{k}} {C}_{i} \vert}^{2}} \qquad ( 8 )$$

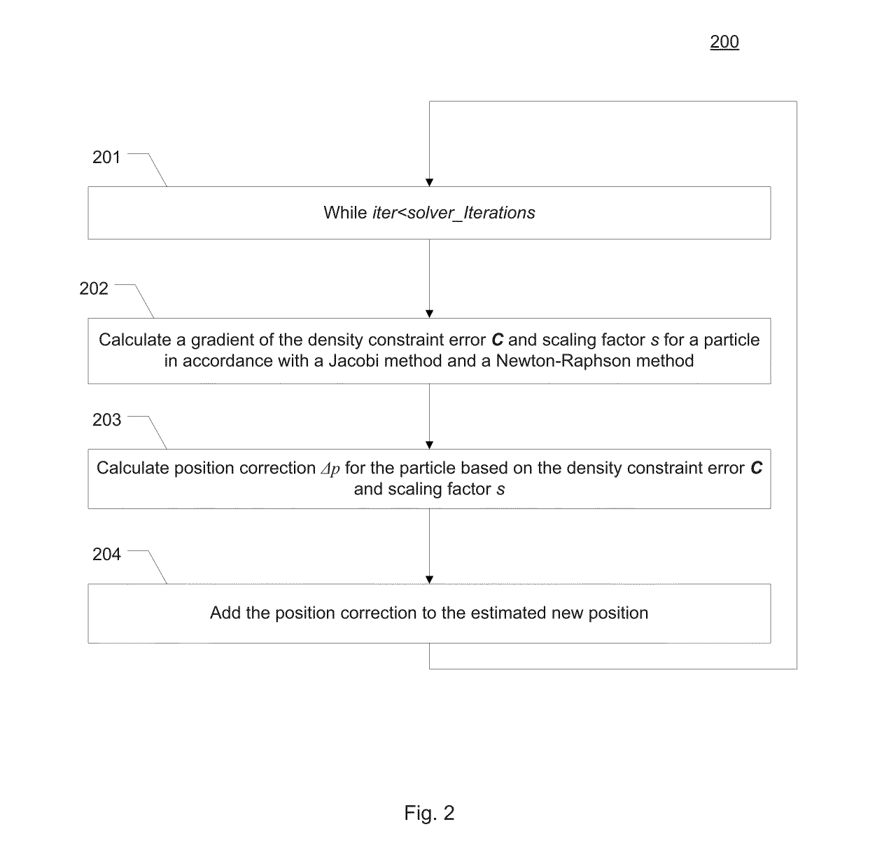

It will be appreciated that the present disclosure is not limited to any specific numerical or mathematical method of solving the constraint formula or equation to derive positions of the particles. FIG. 2 is a flow chart depicting an exemplary computer method 200 of computing a new position of a center particle based by iteratively solving a constraint equation in accordance with an embodiment of the present disclosure. Method 200 expands step 103 of FIG. 1. In this example, the total number of iterations to be performed is set to a constant value, e.g., solver_iterations. In some other embodiments, the total number of iterations may be determined by solving for a specific error threshold.

While “Iter<solver_iteration,” as at 201, a gradient of the constraint C and scaling factor s are calculated iteratively and independently for each particle at 202, for example based on equation (7) and (8). The calculation may be based on a Newton-Raphson method and any suitable iteration method, e.g., a Jacobi method or a Gauss-Seidel iteration method. In some embodiments, collision detection against an external object, e.g., a solid object, can also be included in the constraint solving loop. At 203, a position correction Δpᵢ can be calculated for each particle, for example based on equation (7). At 204, the position correction Δpᵢ is added with the estimated position pᵢ to generate the new position that satisfies the density constraint.

Because the constraint function (1) can be non-linear, with a vanishing gradient at the smoothing kernel boundary, the denominator in equation (2) may cause instability when particles are close to separating. In some embodiments, this problem can be addressed by pre-computing a conservative corrective scale based on a reference particle configuration with a filled neighborhood, as used in a conventional predictive corrective incompressible SPH (PCISPH) method.

In some other embodiments, a constraint force mixing (CFM) method can be used to regularize a constraint, in which the constraint can be softened by mixing in some of the constraint force back into the constraint function, in the case of PBD, this changes (6) to

C(p+Δp)≈C(p)+∇C^{T}∇Cλ+ελ=0 (9)

Where ε is a user specified relaxation parameter which can be a constant over the simulation. The scaling factor is now

$${λ}_{i} = - \frac{{C}_{i} ( {p}_{l} , ⋯ , {p}_{n} )}{{\sum }_{k} {\vert {∇}_{{p}_{k}} {C}_{i} \vert}^{2} + ɛ} . \qquad ( 10 )$$

and the total position update Δpᵢ including corrections from neighbor particles density constraint (λⱼ) is

$$Δ {p}_{i} = \frac{1}{{ρ}_{0}} {\sum }_{j} ( {λ}_{i} + {λ}_{j} ) ∇ W ( {p}_{i} - {p}_{j} , h ) . \qquad ( 11 )$$

Conventional SPH simulation methods typically suffer from the problem of particle clustering or clumping caused by negative pressure when a particle has only a few neighbors and is unable to satisfy the rest density. In embodiments of the present disclosure, an artificial pressure specified in terms of the smoothing kernel itself can be incorporated to avoid this problem. For example, the artificial pressure may be formulated as a correction of the scaling factor

$${s}_{corr} = {k ( \frac{W ( {p}_{i} - {p}_{j} , h )}{W ( Δ q , h )} )}^{n} , \qquad ( 12 )$$

where Δq is a point some fixed distance inside the smoothing kernel radius and k is a small positive constant. For instance, |Δq|=0.1h . . . 0.3h, k=0.1 and n=4. This term can then be included in the particle position update as

$$Δ {p}_{i} = \frac{1}{{ρ}_{0}} {\sum }_{j} ( {λ}_{i} + {λ}_{j} + {s}_{corr} ) ∇ W ( {p}_{i} - {p}_{j} , h ) . \qquad ( 13 )$$

This purely repulsive term can be used to keep particle density slightly lower than the rest density. Consequently, particles pull their neighbors inwards causing surface tension-like effects. In some embodiments, the artificial pressure term is dependent on the spatial resolution and time-step. In some other embodiments, the artificial pressure, spatial resolution and time-step parameters are decoupled, which can advantageously offer anti-clustering effect independent from surface tension effects.

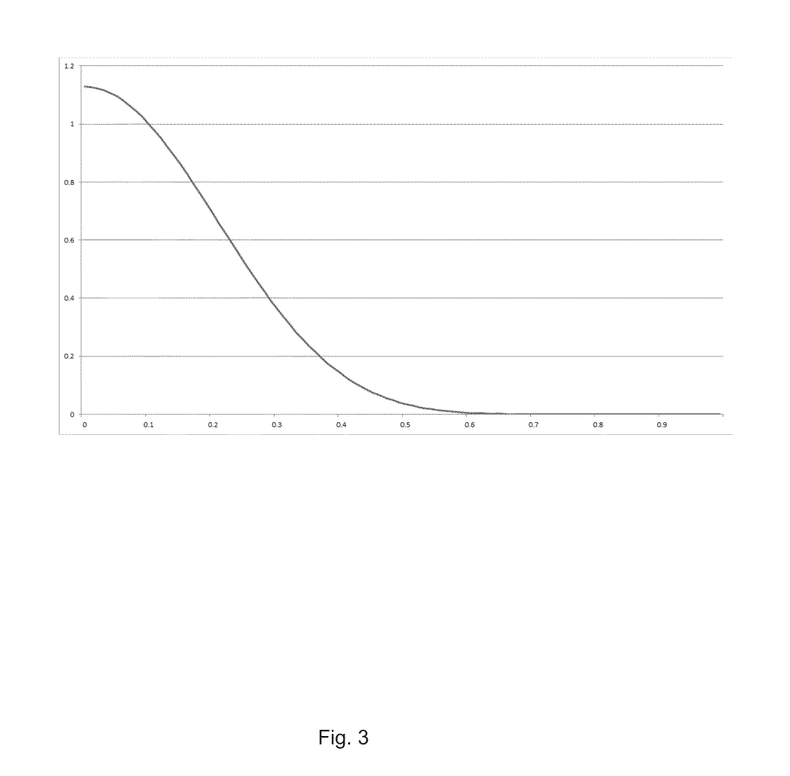

FIG. 3 is a data plot showing an exemplary pressure term for |Δq|=0.1h, k=0.1 and n=4. The horizontal axis is |p₁−pⱼ| going from zero to the smoothing kernel radius h=1. This algorithm can advantageously free the rule of thumb that (in a SPH method) a particle must have 30-40 neighbors at all times. By reducing the minimum neighbor count, the computational efficiency can be advantageously improved.

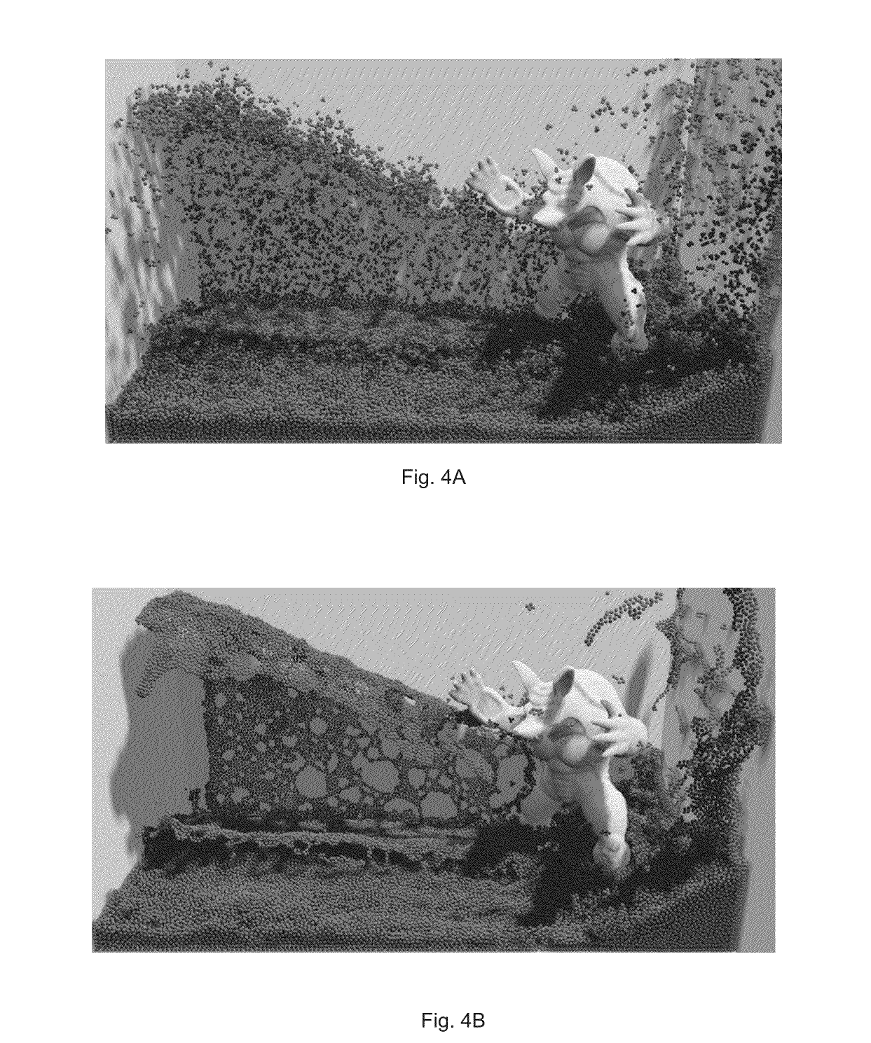

FIG. 4A is a sample illustration of a splashing scenario that is simulated without using an artificial pressure term in accordance with an embodiment of the present disclosure. As shown, fluid particle clumping results from the simulation due to neighbor deficiencies. FIG. 4B is a sample illustration of the splashing scenario that is simulated by incorporating an artificial pressure term in accordance with an embodiment of the present disclosure. It is demonstrated that the fluid particle distribution and surface tension effects are improved.

Conventional position based methods may introduce additional velocity or kinetic energy damping which is often undesirable. In some embodiments of the present disclosure, vorticity confinement can be used to replace the lost energy. This involves calculating the vorticity at a particle's location, e.g., by using an estimator

$${ω}_{i} = ∇ \times v = {\sum }_{j} {v}_{i j} \times {∇}_{{p}_{j}} W ( {p}_{i} - {p}_{j} , h ) \qquad ( 14 )$$

where vᵢⱼ=vⱼ−vᵢ. Then a corrective force can be derived by using the location vector

$$N = \frac{η}{\vert η \vert}$$

with η=∇|ω|ᵢ, e.g.,

fᵢ^{vorticity}=ε(n×ωᵢ). (15)

In some embodiments, an unnormalized curl vector ω can be used such that vorticity only increases where it already exists. In some other embodiments, a normalized ω value is used such that viscosity is increased indiscriminately. Further, viscosity can be incorporated for purposes of achieving coherent motion. For example, the viscosity may be defined as typically used in a conventional XSPH method.

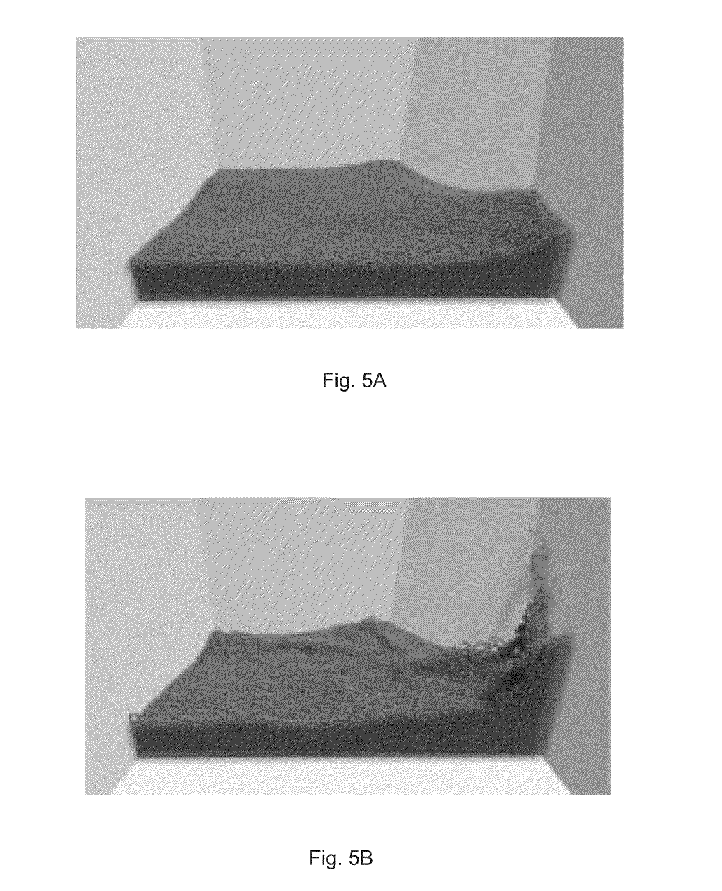

FIG. 5A is a sample illustration of a dam break scenarios that is simulated without incorporating vorticity confinement in accordance with an embodiment of the present disclosure. In contrast, FIG. 5B is sample illustration of the dam break scenarios that is simulated by incorporating vorticity confinement in accordance with an embodiment of the present disclosure.

TABLE 1

| | |
|---|---|
| 1: | for all particles i do |
| 2: | apply forces vᵢ [symbol] vᵢ + Δltₑₓₜ(xᵢ) |
| 3: | predict position xᵢ^{*} [symbol] xᵢ + Δlvⱼ |
| 4: | end for |
| 5: | for all particles i do |
| 6: | find neighboring particles Nᵢ(xᵢ^{*}) |
| 7: | end for |
| 8: | while iter < solverIterations do |
| 9: | for all particles i do |
| 10: | calculate constraint error C and scaling factor x |
| 11: | end for |
| 12: | for all particles i do |
| 13: | calculate Δpᵢ |
| 14: | perform collision detection and response |
| 15: | end for |
| 16: | for all particles i do |
| 17: | update position xᵢ^{*} [symbol] xᵢ^{*} + Δpᵢ |
| 18: | end for |
| 19: | end while |
| 20: | for all particles i do |
| 21: | $update velocity {v}_{i} ⇐ \frac{1}{Δ l} ( {x}_{j}^{*} - {x}_{i} )$ |
| 22: | apply vorticity continement and XSPH viscosity |
| 23: | update position xᵢ [symbol] xᵢ^{*} |
| 24: | end for |

Table 1 provides pseudo-code describing an exemplary PBD simulation loop for simulating fluid object dynamics while maintaining incompressibility in accordance with an embodiment of the present disclosure. Lines 1-4 represent that an estimated velocity is first determined for each particle based on external force fₑₓₜ applied thereon and a time step Δt, and an estimated position is determined based on the estimated velocity. Lines 5-7 represent that a respective set of neighbor particles are identified for each particle based on the estimated positions resulted from Lines 1-4. The neighbor particles can be identified in any suitable method that is well known in the art.

Lines 8-19 represent the computation loop to iteratively compute the constraint error C, the scaling factor, and the position correction for each particle. The constraint error C, the scaling factor, and the position correction can be computed based on above-described equations (7) and (8) respectively for instance. Collision detection and response are also performed in the computation loop. Lines 16-19 represent that the position of each particle is updated by adding the position correction with the estimated position resulted from Lines 1-4. In some embodiments, signed distance fields stored as textures can be used for the particle-solid collision detection. Lines 20-24 represent that the particle velocities are updated based on the updated positions. In turn, particle velocity may be further adjusted by applying vorticity confinement and viscosity, e.g, based on equations (14)-(15).

In this example, distance and constraint values are recalculated in each solver iteration step, and particle neighborhoods are recomputed in each time step. This possibly leads to density underestimates, for example if a particle separates from the initial set of neighbors. In the conventional PCISPH approach, this can cause serious problems because once a particle becomes isolated, each iteration makes its pressure increasingly negative. If it then comes back into contact on a subsequent iteration, large erroneous pressure forces can be accumulated and applied. In contrast, the process according to the present disclosure can process the computation without being affected by such a situation because only the current positions, rather than accumulated pressure, are considered.

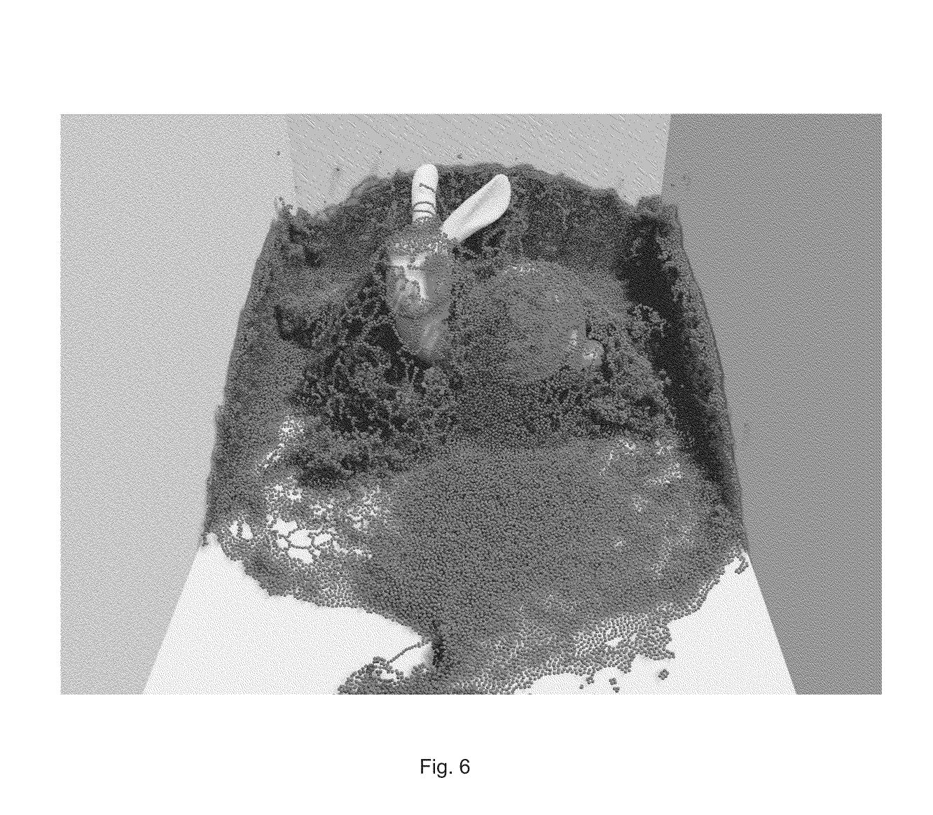

FIG. 6 is a sample illustration of a bunny taking a bath scenario that is simulated in accordance with an embodiment of the present disclosure. The water in the picture is simulated by using 160 k particles and 3 sub-steps per frame with an average simulation time per frame of 15 ms.

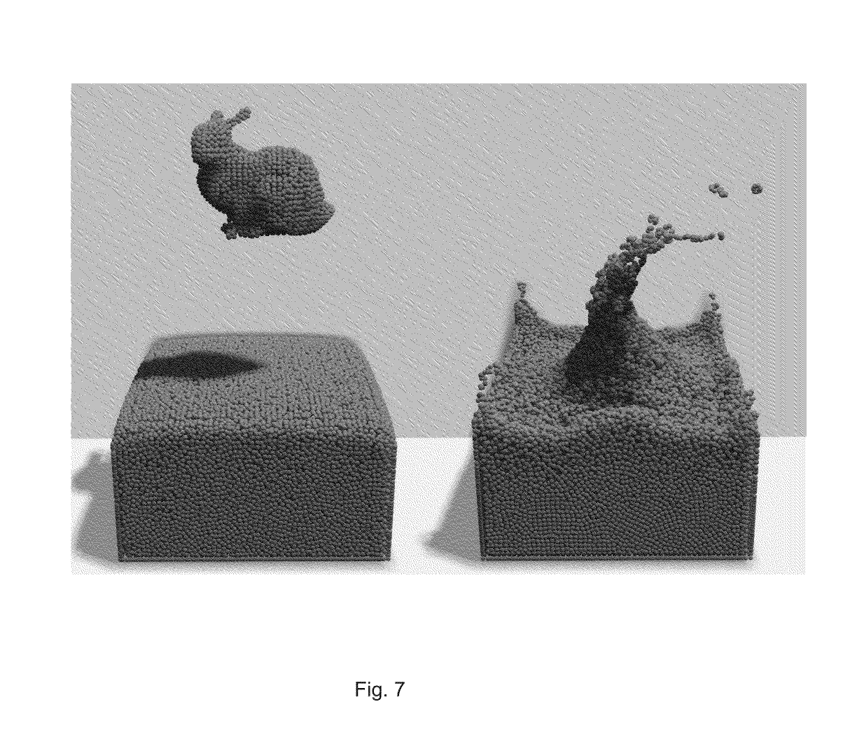

FIG. 7 is a sample illustration showing a liquid bunny that is dropped into a pool of water that is simulated based on the algorithm provided by Table 1 in accordance with an embodiment of the present disclosure.

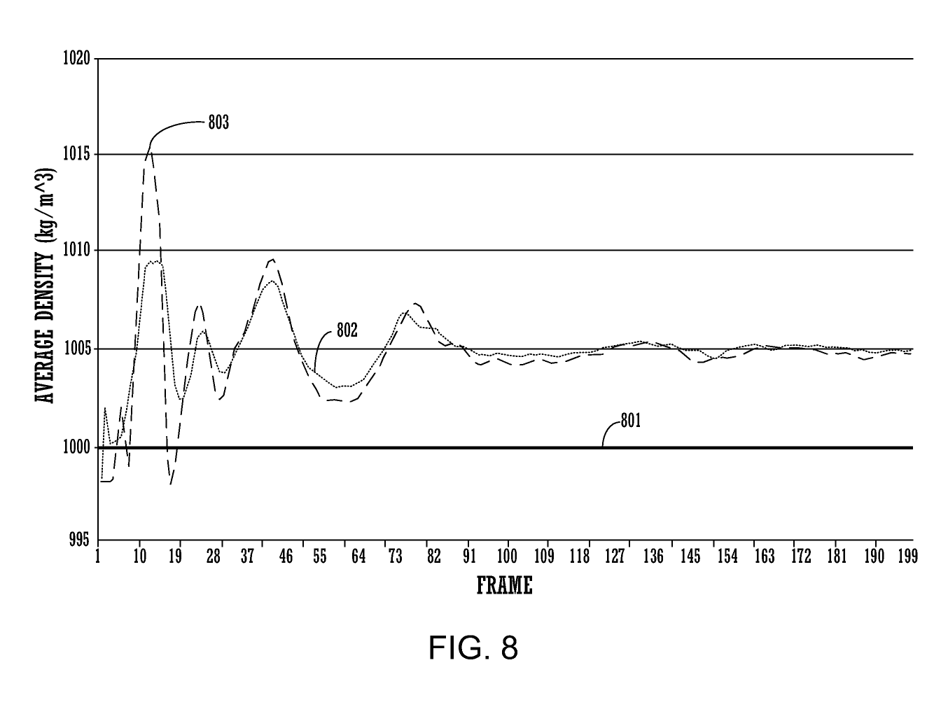

FIG. 8 shows data plots comparing average density over the bunny drop simulation resulted from a conventional PCISPH method 803 and an embodiment of the present disclosure 802. The flat line 801 corresponds to the rest density of the fluid object. For this scenario, it is observed that the PCISPH method is not stable with less than 10 sub-steps per frame (Δt=0.0016 s). In contrast, the embodiment of the present disclosure is stable with a single step (Δt=0.016 s).

The data shown in FIG. 8 are produced by running the PCISPH method with 10 sub-steps and 4 pressure iterations, and by running the embodiment of the present disclosure with 4 sub-steps and 10 iterations per sub-steps, so that each performs 40 pressure iterations per-frame in total. FIG. 8 demonstrates that the level of compression is similar in both simulation processes despite that the time step being 2.5 times larger for the embodiment of the present disclosure.

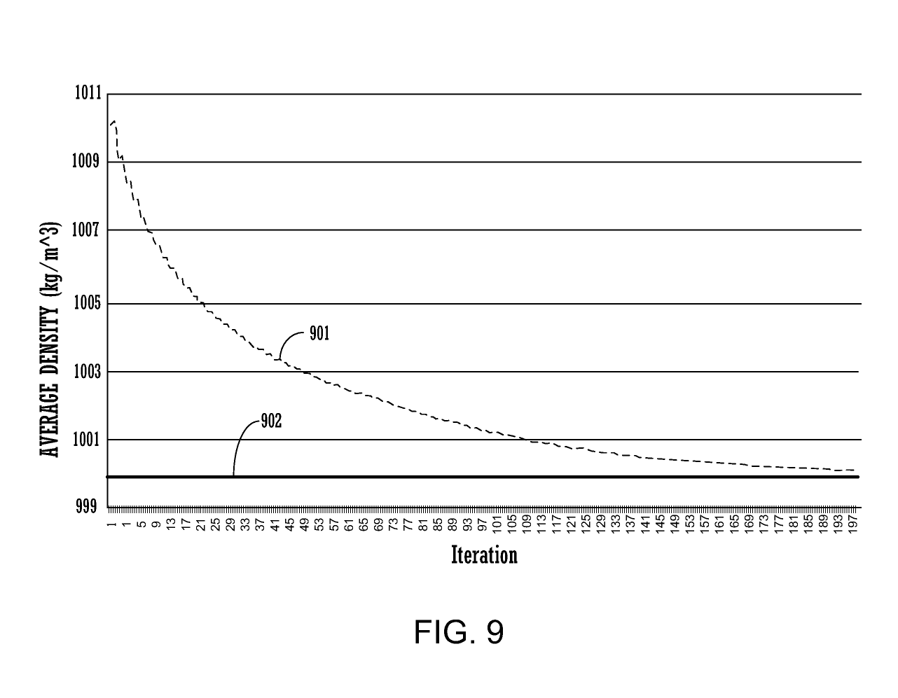

FIG. 9 is a data plot showing convergence performance of an exemplary simulation process that generates the scenario shown in FIG. 7 in accordance with an embodiment of the present disclosure. It demonstrates that the curve 901 representing computed average density data consistently approaches the line 901 representing the rest density, and therefore no convergence problem was encountered during the process. In some embodiments, a red-black scheme can be adopted to achieve better convergence speed.

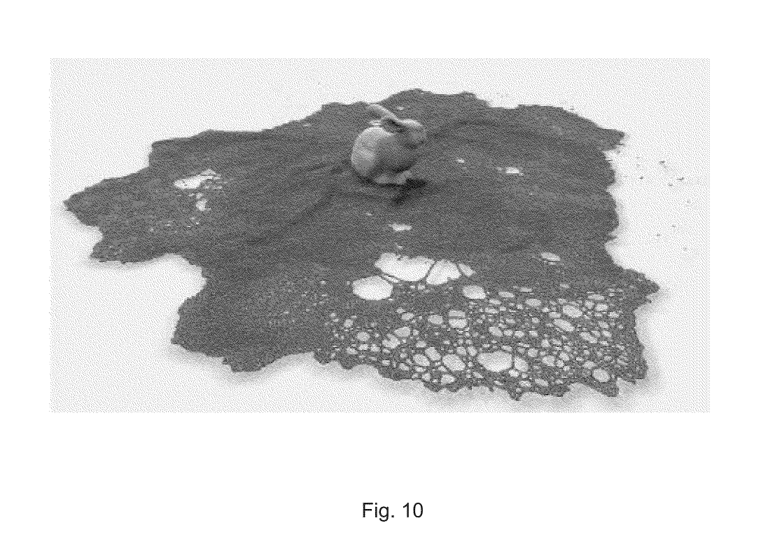

FIG. 10 is a sample simulated picture showing a water puddle scenario with webbing effect that is generated in accordance with an embodiment of the present disclosure. As inferred from the webbing effect in the picture, the simulation process is stable even at low neighbor counts. That is, an algorithm according to the present disclosure is advantageously insensitive to density fluctuations.

Table 2 summarizes the performance results of sample simulation processes in accordance with embodiment of the present disclosure. A frame time of 16 ms is used in all cases listed in Table 2. Table 3 summarizes a breakdown of a frame (percentages) for two examples that generated accordance with embodiment of the present disclosure. In the examples listed in Table 3, constraint solving includes collision handing processes.

TABLE 2

| Scene | particles | steps/frame | iters/step | time/step [ms] |
|---|---|---|---|---|
| Armadillo Splash | 130k | 2 | 3 | 4.2 |
| Dam Break | 100k | 4 | 3 | 4.3 |
| Bunny Drop | 80k | 4 | 10 | 7.8 |

TABLE 3

| Step | Armadillo Splash | Dam Break |
|---|---|---|
| Integrate | 1 | 1 |
| Create Hash Grid | 8 | 6 |
| Detect Neighbors | 28 | 28 |
| Constraint Solve | 38 | 51 |
| Velocity Update | 25 | 14 |

A process according to the present disclosure, e.g., as described in Table 1, can be performed on any suitable processing unit, such as a central processing unit (CPU), or a graphic processing unit (GPU). Each stage of the algorithm is parallelizable, thus making the algorithm suitable for parallel architectures, such as a multi-processor GPU.

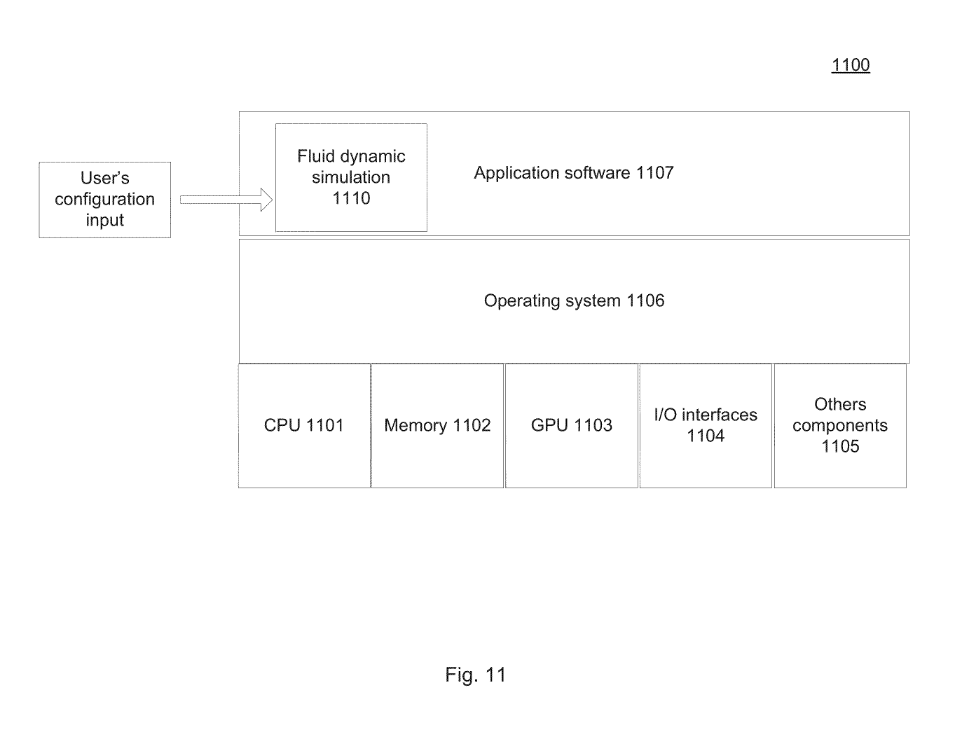

The present disclosure can be applied to simulate a fluid object including a liquid, smoke, fire, explosion and related phenomena. FIG. 11 is a block diagram illustrating an exemplary computing system 1100 including a fluid dynamics simulation program 1110 in accordance with an embodiment of the present disclosure. The computing system comprises a processor 1101, a system memory 1102, a GPU 1103, I/O interfaces 1104 and other components 1105, an operating system 1106 and application software 1107 including the fluid dynamics simulation program 1110 stored in the memory 1102. When incorporating the user's configuration input and executed by the CPU 1101 or the GPU 1103, the fluid dynamics simulation program 1110 can simulate the dynamics of in incompressible fluid object by projecting density constraints in accordance with an embodiment of the present disclosure. The fluid dynamics simulation program 1110 may include various components to compute constraint errors, scaling factors, positions corrections, collision detection and response, voracity, etc. The user configuration input may include an external force applied on the fluid object and an external object that interacts with the fluid object for example. The fluid dynamics simulation program 1110 may be an integral part of a graphic simulation tool, a processing library, or a computer game that is written in Fortran, C++, or any other programming languages known to those skilled in the art.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A computer implemented method of fluid simulation of a fluid object, said computer implemented method comprising:
determining first positions of a plurality of particles;
identifying neighbor particles for a respective particle based on said first positions; and
determining a second position of said respective particle based on a constraint function representing that a density associated with said respective particle at said second position is approximately equal to a rest density of said fluid object, wherein said constraint function is a function of positions of said neighbor particles.

2. The computer implemented method of claim 1, wherein said determining said second position comprises:
computing a position correction for said respective particle based on said constraint function;
adding said position correction with a first position of said respective particle to generate said second position; and
designating said second position as a new position of said respective particle.

3. The computer implemented method of claim 2, wherein said position correction is proportional to a gradient of said constraint function.

4. The computer implemented method of claim 3, wherein said computing said position correction comprises iteratively computing said gradient, a scaling factor, and said position correction in accordance with a substantially Newton-Raphson method and a substantially Jacobi iteration method.

5. The computer implemented method of claim 4, wherein said density is defined based on a smoothing kernel function having a vanishing gradient at a kernel boundary, and further comprising pre-computing a corrective scale based on a reference particle configuration with a filled neighborhood in accordance with a predictive-corrective incompressibility smoothed-particle hydrodynamics (PCISPH) method.

6. The computer implemented method of claim 4, wherein said density is defined based on a smoothing kernel function having a vanishing gradient at a kernel boundary, and further comprising regularizing said constraint function in accordance with a constraint force mixing (CFM) method.

7. The computer implemented method of claim 6 further comprising:
defining a positive artificial pressure in terms of said smoothing kernel function; and
adding said positive artificial pressure to said scaling factor.

8. The computer implemented method of claim 4, wherein said computing said position correction further comprises performing collision detection on said plurality of particles against an external object.

9. The computer implemented method of claim 1 further comprising:
determining a vorticity of said respective particle at said second position by deriving an unnormalized curl of a velocity of said respective particle; and
deriving a corrective force based on said vorticity and corresponding vorticity location vectors.

10. The computer implemented method of claim 1 further comprising:
determining a third position of said respective particle based on said corrective force and a viscosity associated with said respective particle;
defining said third position as a new position of said respective particle; and
computing a velocity of said respective particle based on a difference between said first position and said third position, and a predefined time-step, wherein said time-step is in a range between 4 milliseconds and 20 milliseconds.

11. The computer implemented method of claim 1, wherein said fluid object is incompressible, and wherein said first positions are determined based on an external force applied on said fluid object.

12. A system comprising:
a processing unit; and
a non-transient computer-readable storage medium storing a fluid dynamics simulation program embodying instructions that cause said processing unit to perform:
(a) accessing first positions of a plurality of particles in a fluid object based on an external force applied on said plurality of particles;
(b) identifying neighbor particles for a respective particle based on said first positions; and
(c) determining a position correction of said respective particle based on a constraint function representing that a density associated with said respective particle at said second position is approximately equal to a rest density of said fluid object, wherein said constraint function is a function of positions of said neighbor particles; and
(d) determining a second position of said respective particle by adding said position correction to a first position of said respective particle;
(e) designating said second position as a new position of said respective particle; and
(f) repeating said (b) through (e) for all remaining particles of said plurality of particles.

13. The system of claim 12, wherein said method further comprises:
determining a first velocity of said respective particle based on said external force applied on said respective particle; and
determining said first position based on said first velocity.

14. The system of claim 12, wherein said position correction is equal to a product of a gradient of said constraint function and a scaling factor, and wherein said computing said position correction comprises iteratively computing said gradient and said scaling factor in accordance with a substantially Newton-Raphson method.

15. The system of claim 12, wherein said density is defined based on a Gaussian smoothing kernel function, and wherein said method further comprises modifying said constraint function by incorporating a constraint force to said constraint function, wherein said constraint force comprises a user-specified relaxation parameter.

16. The system of claim 15, wherein said method further comprises:
defining a positive artificial pressure in terms of said Gaussian smoothing kernel function; and
adding said positive artificial pressure to said scaling factor.

17. The system of claim 12, wherein said determining a position correction further comprises performing collision detection and responses for said plurality of particles against an external solid object.

18. The system of claim 12, wherein said method further comprises:
determining a vorticity of said respective particle at said second position by deriving an unnormalized curl of a velocity of said respective particle; and
deriving a corrective force based on said vorticity and vorticity location vectors.

19. The system of claim 12, wherein said processing unit comprises a graphic processing unit (GPU) comprising multiprocessors configured to processing instructions for determining said position correction in parallel.

20. A computer implemented method of simulating fluid dynamics of an incompressible fluid object, said computer implemented method comprises:
determining first velocities and first positions of a plurality of particles in said incompressible fluid object based on an external force applied on said incompressible fluid object;
identifying a set of neighbor particles for a respective particle of said plurality of particles based on said first positions;
determining a second position of said respective particle based on a constraint that a density associated with said respective particle at said second position is approximately equal to a rest density of said incompressible fluid object; and
determining a second velocity of said respective particle based on a difference between a first position of said respective particle and said second position.

21. The computer implemented method of claim 20 further comprising identifying another set of neighbor particles for said respective particle based on said second position, wherein said another set of neighbor particles comprise less than 30 particles.

22. The computer implemented method of claim 20,
wherein said constraint is represented by an equation of state that relates a density constraint function to positions of said set of neighbor particles,
wherein said second position is proportional to a gradient of said density constraint function, and
wherein said determining a second position comprises iteratively computing a gradient of said density constraint function and a scaling factor.
